(19) United States
(12) Patent Application Publication
(10) Pub. No.: US 2021/0215488 A1
(43) Pub. Date: Jul. 15, 2021

(54) Method and Device Used for Filtering Positioning Data

(71) Applicant: Robert Bosch GmbH, Stuttgart (DE)

(72) Inventors: Huajun Yu, Shanghai (CN); Le Cui, Shanghai (CN); Wei Wang, Shanghai (CN); MingLiang Zhang, Shanghai (CN)

(21) Appl. No.: 17/055,494

(22) PCT Filed: May 17, 2018
(86) PCT No.: PCT/CN2018/087199

§ 371 Date: Nov. 13, 2020

(51) Int. Cl. G01C 21/20

(52) U.S. Cl. CPC G01C 21/206

(57) ABSTRACT

A method and apparatus for filtering positioning data includes receiving positioning data outputted at a current moment by a positioning engine; and using an interacting multiple model (IMM) composed of two different filters to filter positioning data to be processed that is based on the received positioning data, to obtain filtered positioning data. Using the method and apparatus, the accuracy and robustness of positioning can be improved.

### TECHNICAL FIELD

The present invention relates to the field of positioning, in particular to a method, apparatus and processing device for filtering positioning data, as well as a positioning device and a computer-readable storage medium.

### BACKGROUND ART

Indoor positioning technology is a technology for positioning a target object (e.g. staff or vehicles, etc.) located indoors; according to this technology, multiple signal emission sources are arranged at different positions indoors, then a positioning engine continuously calculates positioning data of the target object according to signals received from more than one of the signal emission sources, and outputs the calculated positioning data. indoor positioning technology is widely used in many different fields.

Due to obstruction and poor synchronization of the signal emission sources, the positioning data calculated by the positioning engine for indoor positioning often differs from the real position of the target object, and is also not very stable. For this reason, the use of a filter (e.g. a mean filter or Kalman filter, etc.) has already been proposed in the prior art for the purpose of filtering the positioning data outputted by the positioning engine, in order to provide accuracy and robustness of positioning. However, at present, the improvement in accuracy and robustness achieved by this technique of using a filter to filter the positioning data outputted by the positioning engine is still not satisfactory.

### SUMMARY OF THE INVENTION

In view of the above problems in the prior art, the embodiments of the present invention provide a method, apparatus and processing device for filtering positioning data, as well as a positioning device and a computer-readable storage medium, which are capable of improving the accuracy and robustness of positioning.

A method for filtering positioning data according to an embodiment of the present invention comprises: receiving positioning data outputted at a current moment by a positioning engine; and using an interacting multiple model (IMM) composed of two different filters to filter positioning data to be processed that is based on the received positioning data, to obtain filtered positioning data.

An apparatus for filtering positioning data according to an embodiment of the present invention comprises: a receiving module, for receiving positioning data outputted at a current moment by a positioning engine; and a filtering module, for using an interacting multiple model (IMM) composed of two different filters to filter positioning data to be processed that is based on the received positioning data, to obtain filtered positioning data.

A processing device for filtering positioning data according to an embodiment of the present invention comprises: a processor; and a memory, storing an executable instruction which, when executed, causes the processor to execute an operation included in the abovementioned method.

A machine-readable storage medium according to an embodiment of the present invention has an executable instruction thereon; when the executable instruction is executed, a machine is caused to execute an operation included in the abovementioned method.

A positioning device according to an embodiment of the present invention comprises: a positioning engine, for continuously calculating positioning data of a target object and outputting the calculated positioning data; and the abovementioned processing device.

The solution in embodiments of the present invention uses an IMM composed of two filters to filter positioning data outputted by the positioning engine; since the positioning achieved by combining the filtering results of two filters is more accurate and stable than that achieved by a single filter, the solution in embodiments of the present invention can improve the accuracy and robustness of positioning as compared with the prior art.

### BRIEF DESCRIPTION OF THE DRAWINGS

Other features, characteristics, benefits and advantages of the present invention will become more obvious through the following detailed description in conjunction with the drawings, wherein:

FIG. 1 shows a structural schematic diagram of a positioning device according to an embodiment of the present invention.

FIG. 2 shows an overall flow chart of a method for filtering positioning data according to an embodiment of the present invention.

FIG. 3 shows a schematic diagram of a method for filtering positioning data according to an embodiment of the present invention.

FIG. 4 shows a schematic diagram of an apparatus for filtering positioning data according to an embodiment of the present invention.

FIG. 5 shows a schematic diadram of a processing device for filtering positioning data according to an embodiment of the present invention.

FIG. 6 shows a schematic diagram of a positioning device according to an embodiment of the present invention.

### DETAILED DESCRIPTION OF THE INVENTION

Various embodiments of the present invention are described in detail below with reference to the drawings.

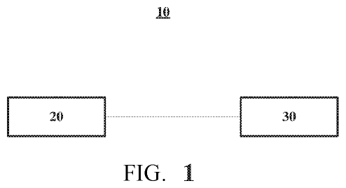

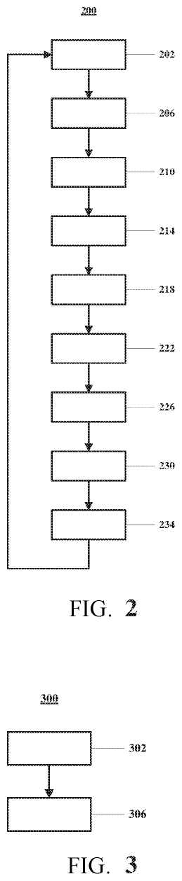

FIG. 1 shows a structural schematic diagram of a positioning device according to an embodiment of the present invention. As shown in FIG. 1, the positioning device 10 may comprise a positioning engine 20 and a processing device 30. The positioning engine 20 is configured to continuously calculate positioning data of a target object T located indoors, for example according to signals received from more than one of multiple signal emission sources placed at different positions indoors, and output the calculated positioning data. The processing device 30 is configured to use an interacting multiple model (abbreviated as IMM) P composed of a first order (FO) Kalman filter and a constant velocity (CV) Kalman filter to filter positioning data outputted at each moment by the positioning engine 20, in order to obtain filtered positioning data for each moment; this is explained in detail below with reference to FIG. 2.

FIG. 2 shows an overall flow chart of a method for filtering positioning data according to an embodiment of the present invention. The method 200 shown in FIG. 2 is implemented by the processing device 30.

As shown in FIG. 2, in box 202, the processing device 30 receives positioning data outputted at the current moment by the positioning engine 20. To facilitate description, supposing the current moment is the moment k, the positioning data outputted by the positioning engine 20 at the current moment is expressed as \hat{X}ₘₑₐₛᵤᵣₑₘₑₙₜ, which is also called an observation value measured by a hardware system.

In box 206, the processing device 30 subjects the received positioning data \hat{X}ₘₑₐₛᵤᵣₑₘₑₙₜ^{k} to preprocessing, to obtain positioning data \hat{X}ₘₑₐₛᵤᵣₑₘₑₙₜ^{k} to be processed. The objective of preprocessing is to eliminate abnormal positioning data which obviously deviates from recently received positioning data. For example but without limitation, if the positioning data \hat{X}ₘₑₐₛᵤᵣₑₘₑₙₜ^{k} is determined as being abnormal positioning data, then the mean value of positioning data received at multiple moments prior to the current moment is calculated as the positioning data Xₘₑₐₛᵤᵣₑₘₑₙₜ^{k} to be processed, and if the positioning data \hat{X}ₘₑₐₛᵤᵣₑₘₑₙₜ^{k} is determined as being normal positioning data, then the positioning data Xₘₑₐₛᵤᵣₑₘₑₙₜ^{k} be processed is the positioning data \hat{X}ₘₑₐₛᵤᵣₑₘₑₙₜ^{k}.

In box 210, the processing device 30 uses equation (1) to calculate a proportion P₁³^{^{k}} of a filtering result of the FO Kalman filter in the IMM P at the current moment (denoting the proportion of the sum of filtering results of the FO Kalman filter and CV Kalman filter in the IMM P at the current moment which is made up by the filtering result of the FO Kalman filter in the IMM P at the current moment) and a proportion P₂³^{^{k}} of a filtering result of the CV Kalman Filter in the IMM P at the current moment (denoting the proportion of the sum of filtering results of the FO Kalman filter and CV Kalman filter in the IMM P at the current moment which is made up by the filtering result of the CV Kalman filter in the IMM P at the current moment).

P₁³^{^{k}}=P₁^{k-1}M₁+P₂^{k-1}M₂, P₂⁴^{^{k−1}}+P₁⁴^{^{k−1}}M₂+P₂^{k-1}M₁ (1)

wherein M₁ denotes the Markov chain transfer probability of the FO Kalman filter in the IMM P, M₂ denotes the Markov chain transfer probability of the CV Kalman filter in the IMM P, where M₁ and M₂ are given constants, P₁^{k-31 1} denotes the probability of the FO Kalman filter being selected by the IMM P at the previous moment (i.e. the moment k−1), P₂^{k-1} denotes the probability of the CV Kalman filter being selected by the IMM P at the previous moment, and P₁^{4k}+P₂^{4k}=1.

In box 214, the processing device 30 uses equations (2) to respectively calculate a mixed input InputMixing_{A1} for the FO Kalman filter in the IMM P and a mixed input InputMixing_{A1} for the CV Kalman filter in the IMM P.

$${InputMixing}_{A 1} = \frac{{p}_{1}^{k - 1} {M}_{1}}{{p}_{1} \text{?}} {X}_{\text{?}} \text{?} + \frac{{p}_{2}^{k - 1} {M}_{2}}{{p}_{1} \text{?}} X \text{?} \\ {InputMixing}_{A 2} = \frac{{p}_{1}^{k - 1} {M}_{2}}{{p}_{2} \text{?}} {X}_{\text{?}} \text{?} + \frac{{p}_{2}^{k - 1} {M}_{1}}{{p}_{2} \text{?}} X \text{?} \\ \text{?} \text{indicates text missing or illegible when filed} \qquad ( 2 )$$

wherein X_{A1_estimates}^{k-1} denotes a preliminary filtering result outputted by the FO Kalman filter in the IMM P at the previous moment, and X_{A2_estimates}^{k-1} denotes a preliminary filtering result outputted by the CV Kalman filter in the IMM P at the previous moment.

In box 218, the processing device 30 uses equations (3) to calculate a positioning data prediction value \hat{X}_{k|k}^{A1} for the FO Kalman filter in the IMM P at the current moment and a positioning data prediction value \hat{X}_{k|k}^{A2} for the CV Kalman filter in the IMM P at the current moment.

\hat{X}_{k|k}^{A1}=Fₖ\hat{X}_{k-1|k-1}^{A1}+Kₖ(InputMixing_{A1}—HFₖ\hat{X}_{k-1|k-1}^{A1}) \hat{X}_{k|k}^{A2}=Fₖ\hat{X}_{k-1|K-1}^{A2}+Kₖ(InputMixing_{A2}—HFₖ^{\hat{X}}_{k-1|k-}^{A2}) (3)

wherein Fₖ denote given and unchanging transfer matrix, H denotes a given and unchanging observation matrix, \hat{X}_{k-1|k-1}^{A1} denotes a positioning data prediction value for the FO Kalman filter in the IMM P at the previous moment, \hat{X}_{k-1|k-1}^{A2} denotes a positioning data prediction value for the CV Kalman filter in the IMM P at the previous moment, Kₖ denotes a coefficient gain at the current moment, Kₖ=\hat{P}_{k|k-1}H^{T}(H\hat{P}_{k|k-1}H^{T}+R)⁻¹, R denotes a given and unchanging measurement noise covariance, \hat{P}_{k|k-1} denotes an “a priori” covariance matrix at the current moment, \hat{P}_{k|k-1}=Fₖ\hat{P}_{k-1|k-1}Fₖ^{T}+Q, Q denotes a given and unchanging processing noise covariance, and \hat{P}_{k-1|k-1} denotes an “a priori” covariance matrix at the previous moment.

In box 222, the processing device 30 uses the FO Kalman filter in the IMM P to filter the positioning data prediction value \hat{X}_{k|k1}^{A1}, the filtering result thus obtained serving as a preliminary filtering result X_{A1_estimates}^{k} of the FO Kalman filter in the IMM P at the current moment, and uses the CV Kalman filter in the IMM P to filter the positioning data prediction value \hat{X}_{k|k}^{A2} the filtering result thus obtained serving as a preliminary filtering result of the X_{A2_estimates}^{k} of the CV Kalman filter in the IMM P at the current moment.

In box 226, the processing device 30 uses equations (4) to calculate a filtering parameter value eK_{A1} for the FO Kalman filter in the IMM P and a filtering parameter value eK_{A2} for the CV Kalman filter in the IMM P.

$${eK}_{A 1} = e \text{?} \\ {eK}_{A 2} = e \text{?} \\ \text{?} \text{indicates text missing or illegible when filed} \qquad ( 4 )$$

wherein Pₙₒᵢₛₑ denotes a given and unchanging measurement noise covariance.

In box 230, the processing device 30 uses equations (5) to calculate the probability p₁^{k} of the FO Kalman filter being selected by the IMM P at the current moment and the probability p₂^{k} of the CV Kalman filter being selected by the IMM P at the current. moment.

$${p}_{1}^{k} = \frac{eK \text{?} * p \text{?}}{eK \text{?} * p \text{?} + eK \text{?} * p \text{?}} , \\ {p}_{2}^{k} = \frac{eK \text{?} * p \text{?}}{eK \text{?} * p \text{?} + eK \text{?} * p \text{?}} \\ \text{?} \text{indicates text missing or illegible when filed} \qquad ( 5 )$$

In box 234, the processing device 30 uses equation (6) to calculate a filtering output of the IMM P, as a filtering result of the IMM P for the positioning data to be processed Xₘₑₐₛᵤᵣₑₘₑₙₜₛ^{k} at the current moment.

Output=p₁^{k}X_{A1_estimated}^{k}+p₂^{k}X_{A2_estimated}^{k} (6)

Next, after box 234, the procedure returns to box 202, in order to filter positioning data Xₘₑₐₛᵤᵣₑₘₑₙₜₛ^{k+1}; outputted by the positioning engine at the next moment (i.e. moment k+1).

The solution of this embodiment uses an IMM composed of two filters (i.e. the FO Kalman filter and CV Kalman filter) to filter positioning data outputted by the positioning engine; since the positioning achieved by combining the filtering results of two filters is more accurate and stable than that achieved by a single filter, the solution of this embodiment can improve the accuracy and robustness of positioning.

Other Variants

Those skilled in the are will understand that although the positioning data prediction value for the FO Kalman filter in the IMM P at the current moment and the positioning data prediction value for the CV Kalman filter in the IMM P at the current moment are calculated using equations (3) in the above embodiment, the present invention is not limited to this. In other embodiments of the present invention, it is also possible for the filtering parameter value eK_{A1} for the FO Kalman filter in the IMM P, calculated using equations (4), to serve as the positioning data prediction value for the FO Kalman filter in the IMM P at the current moment, and the filtering parameter value eK_{A2} for the CV Kalman filter in the IMM P, calculated using equations (4), to serve as the positioning data prediction value for the CV Kalman filter in the IMM P at the current moment; in this case, \hat{X}_{k|k}^{A1} and \hat{X}_{k|k}^{A2} calculated using equations (3) are an auxiliary calculation value for the FO Kalman filter in the IMM P at the current moment, and an auxiliary calculation value for the CV Kalman filter in the IMM P at the current moment, respectively.

Those skilled in the art will understand that although the method 200 comprises box 206 to preprocess the received positioning data \hat{X}ₘₑₐₛᵤᵣₑₘₑₙₜₛ^{k} in the above embodiment, the present invention is not limited to this. In other embodiments of the present invention, the method 200 may not include box 206; in this case, the positioning data to be processed Xₘₑₐₛᵤᵣₑₘₑₙₜₛ^{k} is the received positioning data \hat{X}ₘₑₐₛᵤᵣₑₘₑₙₜ^{k}.

Those skilled in the art will understand that although the IMM P is composed of the FO Kalman filter and CV Kalman filter in the above embodiment, the present invention is not limited to this. In other embodiments of the present invention, the IMM P could for example be composed of either one of the FO Kalman filter and CV Kalman filter, and another filter (e.g., a mean value filter, etc.), or for example composed of two filters other than the FO Kalman filter and CV Kalman filter.

Those skilled in the art will understand that the solution of the present invention is suitable not only for indoor positioning scenarios but also for outdoor positioning scenarios.

FIG. 3 shows a flow chart of a method for filtering positioning data according to an embodiment of the present invention. The method 300 shown in FIG. 3 may be implemented by the processing device 30 or another suitable device.

As shown in FIG. 3, the method 300 may comprise, in box 302, receiving positioning data outputted at a current moment by a positioning engine.

The method 300 may further comprise, in box 306, using an IMM composed of two different filters to filter positioning data to be processed that is based on the received positioning data, in order to obtain filtered positioning data. Here, the positioning data to be processed may be the received positioning data, or positioning data obtained by preprocessing the received positioning data.

In a first aspect, box 306 may comprise: acquiring respective preliminary filtering results of the two filters at the current moment, the preliminary filtering results being associated with the positioning data to be processed (for example but without limitation, implemented via boxes 210-222); calculating respective probabilities of selection of the two filters at the current moment, wherein the probability of selection of each filter at the current moment represents the probability that the IMM will select said filter at the current moment. (for example but without limitation, implemented via boxes 210-230); and calculating the sum of the respective products of the preliminary filtering result and probability of selection of each of the two filters at the current moment, to serve as the filtered positioning data (for example but without limitation, calculated using equation (6)).

In a second aspect, the step of acquiring respective preliminary filtering results of the two filters at the current moment comprises: based on respective Markov chain transfer probabilities of the two filters and respective probabilities of selection of the two filters at a previous moment preceding the current moment, calculating respective filtering result proportions of the two filters at the current moment (for example but without limitation, calculated using equation (1)), wherein the filtering result proportion of either one of the two filters at the current moment represents the proportion of the sum of filtering results of the two filters at the current moment that is made up by the filtering result of said either one of the two filters at the current moment; calculating respective mixed inputs for the two filters (for example but without limitation, calculated using equations (2)), wherein the mixed input for each filter is calculated on the basis of the positioning data to be processed, a preliminary filtering result of said filter at the previous moment, the respective Markov chain transfer probabilities of the two filters, and the respective probabilities of selection of the two filters at the previous moment; calculating a positioning data prediction value for each of the two filters at the current moment (for example but without limitation, calculated using equations (3)); and obtaining respective preliminary filtering results of the two filters at the current moment, by using each of the two filters to filter the positioning data prediction. value for said filter at the current moment (for example but without limitation, implemented via box 222).

In a third aspect, the positioning data prediction value for each of the two filters at the current moment is calculated on the basis of a positioning data prediction value for said filter at the previous moment, the calculated mixed input for said filter, a given and unchanging transfer matrix, a given and unchanging observation matrix, and a coefficient gain at the current moment (for example but without limitation, calculated using equations (3).

In a fourth aspect, the step of calculating a positioning data prediction value for each of the two filters at the current moment comprises: calculating an auxiliary calculation value for each of the two filters at the current moment, the auxiliary calculation value being calculated on the basis of an auxiliary calculation value for said filter at the previous moment, the calculated mixed input for said filter, a given and unchanging transfer matrix, a given and unchanging observation matrix, and a coefficient gain at the current moment (for example but without limitation, calculated using equations (3)); and determining a positioning data prediction value for each of the two filters at the current moment, the positioning data prediction value being calculated on the basis of the positioning data to be processed, the auxiliary calculation value for said filter at the current moment, and a given and unchanging measurement noise covariance (for example but without limitation, calculated using equations (4)).

In a fifth aspect, the step of calculating respective probabilities of selection of the two filters at the current moment comprises: calculating respective filtering parameter values for the two filters, wherein the filtering parameter value for each of the two filters is calculated on the basis of the positioning data to be processed, the positioning data prediction value for said filter at the current moment, and a given and unchanging measurement noise covariance (for example but without limitation, calculated using equations (4)); and based on the respective filtering parameter values for the two filters and the respective filtering result proportions of the two filters at the current moment, determining respective probabilities of selection of the two filters at the current moment (for example but without limitation, calculated using equations (5)).

In a sixth aspect, the method 200 may further comprise: preprocessing the received positioning data, to obtain the positioning data to be processed (for example but without limitation, implemented via box 206).

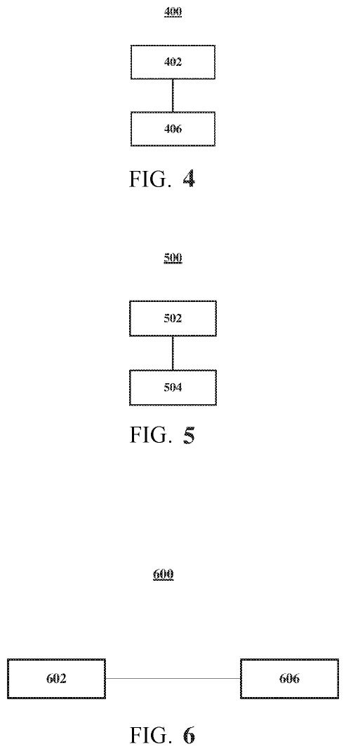

FIG. 4 shows a schematic diagram of an apparatus for filtering positioning data according to an embodiment of the present invention. The apparatus 400 shown in FIG. 4 may be implemented using software, hardware or a combination of software and hardware. The apparatus 400 shown in FIG. 4 may be installed in the processing device 30 or in another suitable device.

As shown in FIG. 4, the apparatus 400 may comprise a receiving module 402 and a filtering module 406. The receiving module 402 is configured to receive positioning data outputted by a positioning engine at a current moment. The filtering module 406 is configured to use an IMM composed of two different filters to filter positioning data to be processed that is based on the received positioning data, in order to obtain filtered positioning data.

In a first aspect, the filtering module 406 comprises: an acquisition module, for acquiring respective preliminary filtering results of the two filters at the current moment, the preliminary filtering results being associated with the positioning data to be processed; a first calculation module, for calculating respective probabilities of selection of the two filters at the current moment, wherein the probability of selection of each filter at the current moment represents the probability that the IMM will select said filter at the current moment; and a second calculation module, for calculating the sum of the respective products of the preliminary filtering result and probability of selection of each of the two filters at the current moment, to serve as the filtered positioning data.

In a second aspect, the acquisition module comprises: a third calculation module, for calculating respective filtering result proportions of the two filters at the current moment, based on respective Markov chain transfer probabilities of the two filters and respective probabilities of selection of the two filters at the previous moment preceding the current moment, wherein the filtering result proportion of either one of the two filters at the current moment represents the proportion of the sum of filtering results of the two filters at the current moment that is made up by the filtering result of said either one of the two filters at the current moment; a fourth calculation module, for calculating respective mixed inputs for the two filters, wherein the mixed input for each filter is calculated on the basis of the positioning data to be processed, a preliminary filtering result of said filter at the previous moment, the respective Markov chain transfer probabilities of the two filters, and the respective probabilities of selection of the two filters at the previous moment; a fifth calculation module, for calculating a positioning data prediction value for each of the two filters at the current moment; and an obtaining module, for obtaining respective preliminary filtering results of the two filters at the current moment, by using each of the two filters to filter the positioning data prediction value for said filter at the current moment.

In a third aspect, the positioning data prediction value for each of the two filters at the current moment is calculated on the basis of a positioning data prediction value for said filter at the previous moment, the calculated mixed input for said filter, a given and unchanging transfer matrix, a given and unchanging observation matrix, and a coefficient gain at the current moment.

In a fourth aspect, the fifth calculation module comprises: a sixth calculation module, for calculating an auxiliary calculation value for each of the two filters at the current moment, the auxiliary calculation value being calculated on the basis of an auxiliary calculation value for said filter at the previous moment, the calculated mixed input for said filter, a given and unchanging transfer matrix, a given and unchanging observation matrix, and a coefficient gain at the current moment; and a first determining module, for determining a positioning data prediction value for each of the two filters at the current moment, the positioning data prediction value being calculated on the basis of the positioning data to be processed, the auxiliary calculation value for said filter at the current moment, and a given and unchanging measurement noise covariance, in a fifth aspect, the first calculation module comprises: a seventh calculation module, for calculating respective filtering parameter values for the two filters, wherein the filtering parameter value for each of the two filters is calculated on the basis of the positioning data to be processed, the positioning data prediction value for said filter at the current moment, and a given and unchanging measurement noise covariance; and a second determining module, for determining respective probabilities of selection of the two filters at the current moment, based on the respective filtering parameter values for the two filters and the respective filtering result proportions of the two filters at the current moment.

In a sixth aspect, the apparatus 400 may further comprise: a preprocessing module, for preprocessing the received positioning data, to obtain the positioning data to be processed.

FIG. 5 shows a schematic diagram of a processing device for filtering positioning data according to an embodiment of the present invention. As shown in FIG. 5, the processing device 500 may comprise a processor 502, and a memory 504 coupled to the processor 502. The memory 504 stores an executable instruction which, when executed, causes the processor 502 to execute the method 200 shown in FIG. 2 or the method 300 shown in FIG. 3. The processing device 500 may be realized by the processing device 30 or another suitable device.

An embodiment of the present invention further provides a machine-readable storage medium, having an executable instruction thereon; when the executable instruction is executed, a machine is caused to execute the method 200 shown in FIG. 2 or the method 300 shown in FIG. 3.

FIG. 6 shows a schematic diagram of a positioning device according to an embodiment of the present invention. As shown in FIG. 6, the positioning device 600 may comprise a positioning engine 602 and a processing device 606. The positioning engine 602 continuously calculates positioning data of a target object and outputs the calculated positioning data to the processing device 606; the positioning engine 602 may for example, but without limitation, be realized by the positioning engine 20. The processing device 606 may for example, but without limitation, be realized by the processing device 500.

Those skilled in the art should understand that various alterations, amendments and changes may be made to the embodiments disclosed above without departing from the substance of the invention, and all such alterations, amendments and changes should fall within the scope of protection of the present invention. Thus, the scope of protection of the present invention is defined by the attached claims.

1. A method for filtering positioning data, comprising:
receiving positioning data outputted at a current moment by a positioning engine; and
using an interacting multiple model (IMM) comprising two different filters to filter positioning data to be processed that is based on the received positioning data, to obtain filtered positioning data.

2. The method according to claim 1, wherein of using the IMM comprising two different filters to filter positioning data to be processed that is based on the received positioning data comprises:
acquiring respective preliminary filtering results of the two filters at the current moment, wherein the preliminary filtering results are associated with the positioning data to be processed;
calculating respective probabilities of selection of the two filters at the current moment, wherein the probability of selection of each filter at the current moment represents a probability that the IMM will select said filter at the current moment; and
calculating a sum of respective products of the preliminary filtering result and the probability of selection of each of the two filters at the current moment, to obtain the filtered positioning data.

3. The method according to claim 2, wherein of acquiring the respective preliminary filtering results of the two filters at the current moment comprises:
based on respective Markov chain transfer probabilities of the two filters and respective probabilities of selection of the two filters at a previous moment preceding the current moment, calculating respective filtering result proportions of the two filters at the current moment, wherein the filtering result proportion of either one of the two filters at the current moment represents a proportion of a sum of the filtering results of the two filters at the current moment that is made up by the filtering result of said either one of the two filters at the current moment;
calculating respective mixed inputs for the two filters, wherein the mixed input for each filter is calculated based on the positioning data to be processed, a preliminary filtering result of said filter at the previous moment, the respective Markov chain transfer probabilities of the two filters, and the respective probabilities of selection of the two filters at the previous moment;
calculating a positioning data prediction value for each of the two filters at the current moment; and
obtaining the respective preliminary filtering results of the two filters at the current moment, by using each of the two filters to filter the positioning data prediction value for said filter at the current moment.

4. The method according to claim 3, wherein the positioning data prediction value for each of the two filters at the current moment is calculated based on of a positioning data prediction value for said filter at the previous moment, the calculated mixed input for said filter, a given and unchanging transfer matrix, a given and unchanging observation matrix, and a coefficient gain at the current moment.

5. The method according to claim 3, wherein calculating the positioning data prediction value for each of the two filters at the current moment comprises:
calculating an auxiliary calculation value for each of the two filters at the current moment, the auxiliary calculation value calculated based on an auxiliary calculation value for said filter at the previous moment, the calculated mixed input for said filter, a given and unchanging transfer matrix, a given and unchanging observation matrix, and a coefficient gain at the current moment; and
determining the positioning data prediction value for each of the two filters at the current moment, the positioning data prediction value calculated based on the positioning data to be processed, the auxiliary calculation value for said filter at the current moment, and a given and unchanging measurement noise covariance.

6. The method according to claim 4, wherein calculating the respective probabilities of selection of the two filters at the current moment comprises:
calculating respective filtering parameter values for the two filters, wherein the filtering parameter value for each of the two filters is calculated based on the positioning data to be processed, the positioning data prediction value for said filter at the current moment, and a given and unchanging measurement noise covariance; and
based on the respective filtering parameter values for the two filters and the respective filtering result proportions of the two filters at the current moment, determining the respective probabilities of selection of the two filters at the current moment.

7. The method according to claim 1, further comprising:
preprocessing the received positioning data, to obtain the positioning data to be processed.

8. An apparatus for filtering positioning data, comprising:
a receiving module configured to receive positioning data outputted at a current moment by a positioning engine; and
a filtering module configured to use an interacting multiple model (IMM) comprising two different filters to filter positioning data to be processed based on the received positioning data, to obtain filtered positioning data.

9. The apparatus according to claim 8, wherein the filtering module comprises:
an acquisition module configured to acquire respective preliminary filtering results of the two filters at the current moment, the preliminary filtering results associated with the positioning data to be processed;
a first calculation module configured to calculate respective probabilities of selection of the two filters at the current moment, the probability of selection of each filter at the current moment representing a probability that the IMM will select said filter at the current moment; and
a second calculation module configured to calculate a sum of respective products of the preliminary filtering result and the probability of selection of each of the two filters at the current moment, to obtain the filtered positioning data.

10. The apparatus according to claim 9, wherein the acquisition module comprises:
a third calculation module configured to calculate respective filtering result proportions of the two filters at the current moment, based on respective Markov chain transfer probabilities of the two filters and respective probabilities of selection of the two filters at a previous moment preceding the current moment, wherein the filtering result proportion of either one of the two filters at the current moment represents a proportion of a sum of the filtering results of the two filters at the current moment that is made up by the filtering result of said either one of the two filters at the current moment;
a fourth calculation module configured to calculate respective mixed inputs for the two filters, wherein the mixed input for each filter is calculated based on of the positioning data to be processed, the preliminary filtering result of said filter at the previous moment, the respective Markov chain transfer probabilities of the two filters, and the respective probabilities of selection of the two filters at the previous moment;
a fifth calculation module configured to calculate a positioning data prediction value for each of the two filters at the current moment; and
an obtaining module configured to obtain the respective preliminary filtering results of the two filters at the current moment using each of the two filters to filter the positioning data prediction value for said filter at the current moment.

11. The apparatus according to claim 10, wherein the positioning data prediction value for each of the two filters at the current moment is calculated based on a positioning data prediction value for said filter at the previous moment, the calculated mixed input for said filter, a given and unchanging transfer matrix, a given and unchanging observation matrix, and a coefficient gain at the current moment.

12. The apparatus according to claim 10, wherein the fifth calculation module comprises:
a sixth calculation module configured to calculate an auxiliary calculation value for each of the two filters at the current moment, the auxiliary calculation value calculated based on an auxiliary calculation value for said filter at the previous moment, the calculated mixed input for said filter, a given and unchanging transfer matrix, a given and unchanging observation matrix, and a coefficient gain at the current moment; and
a first determining module configured to determine a positioning data prediction value for each of the two filters at the current moment, the positioning data prediction value calculated based on of the positioning data to be processed, the auxiliary calculation value for said filter at the current moment, and a given and unchanging measurement noise covariance.

13. The apparatus according to claim 11, wherein the first calculation module comprises:
a seventh calculation module configured to calculate respective filtering parameter values for the two filters, the filtering parameter value for each of the two filters calculated based on the positioning data to be processed, the positioning data prediction value for said filter at the current moment, and a given and unchanging measurement noise covariance; and
a second determining module configured to determine respective probabilities of selection of the two filters at the current moment, based on the respective filtering parameter values for the two filters and the respective filtering result proportions of the two filters at the current moment.

14. The apparatus according to claim 8, further comprising:
a preprocessing module configured to preprocess the received positioning data, to obtain the positioning data to be processed.

15. A processing device for filtering positioning data, comprising:
a processor; and
a memory configured to store an executable instruction which, when executed, causes the processor to (i) receive positioning data outputted at a current moment by a positioning engine; and (ii) use an interacting multiple model (IMM) comprising two different filters to filter positioning data to be processed that is based on the received positioning data, to obtain filtered positioning data.

16. The method according to claim 1, wherein:
a machine-readable storage medium has an executable instruction thereon; and
when the executable instruction is executed, a machine is caused to execute the method.

17. The processing device according to claim 15 wherein the processing device is included in a positioning engine configured to continuously calculate the positioning data of a target object and to output the calculated positioning data.
